(19) United States
(12) Patent Application Publication
(10) Pub. No.: US 2002/0159684 A1
(43) Pub. Date: Oct. 31, 2002

(54) Novel optical waveguide switch using cascaded mach-zehnder interferometers

(75) Inventors: De-Gui Sun, Ottawa (CA); Yitao Sun, Ottawa (CA)

Correspondence Address: FRIEDRICH KUEFFNER, SUITE 1921, 342 MADISON AVENUE, NEW YORK, NY, 10173, US

(73) Assignee: Zenastra Photonics Inc.

(21) Appl. No.: 09/808,901

(22) Filed: Mar. 15, 2001

(51) Int. Cl. G02B 6/35

(52) U.S. Cl. 385/20; 385/22; 385/39

(57) ABSTRACT

An optical signal switch has improved port isolation and extinction ratio by utilizing cascaded or tandem Mach-Zehnder Interferometer (MZI) with thermo-optical or electro-optical refractive index-modulating electrodes on the MZI arms.

### BACKGROUND OF THE INVENTION

1. Field of the Invention

The present invention relates to optical waveguide switches in general and in particular to switches utilizing double-track cascaded Mach-Zehnder interferometers. It provides optical switches with high isolation for optical communication systems, optical interconnects, optical cross-connects, and large-scale fiber-optic network systems. Relevant Art The rapid development and applications of fiber-optic telecommunication systems require new microstructure optoelectronic technologies rather than individual mechanical devices. Among such optoelectronic technologies, integrated optics represents a promising strategy. One implementation of this strategy relies on the integration of optoelectronic interconnects on a host Silicon (Si) substrate, and thus requires Si-based photonic devices. Thermo-optic (TO) waveguide devices using PECVD-based silica-on-silicon have shown an advantage over currently used mechanical and bulk optic devices in fiber-optic telecommunications because of their flexibility in fabrication and processing, as well as speed of operation compared to mechanical ones. Electro-optic (EO) waveguide devices using diffused LiNbO₃-based waveguides also provide promising applications in the future due to their high-speed operation, low loss and mature manufacturing technology. Among active devices in optical communication systems, optical space switches are key components. For example, a 2×2 or 1×2 switch is not only used directly in various optical switching systems as a single device, but also as a primitive for building various large-scale switching devices. Beyond the traditional applications, optical switches play an increasingly critical role in emerging multi-channel and re-configurable photonic networks such as the dense wavelength division multiplexing (DWDM) which is gaining importance in fiber-optic telecommunication systems. Some typical and important components such as optical multiplexers (MUX), optical demultiplexers (DEMUX), 2×2 optical switches, and variable optical attenuators are used to build configurable optical add/drop multiplexing (C-OADM) systems. This is a typical and popular application of 2×2 optical switches (OS) in DWDM systems.

Most of the optical switches in production today use opto-mechanical means to implement optical steering. This is accomplished through the separation, or the alignment, or the reflection of the light beam by an opto-mechanically driven mirror. Such designs offer good optical performance, but have two main drawbacks. One is slow speed, the typical settling times for switching being from 10 ms to 100 ms. The other drawback includes noise and size. In an era when the use of electronics is considered an intrusion in the all-optical networks, mechanically based devices are out of place. To overcome some of these limitations, non-mechanical and no-moving-part optical switches in the market now use a variety of design concepts. Both EO and TO waveguide switches not only improve operational speed compared to opto-mechanical switches, but also make integrated optic circuits possible. In telecommunication systems, optical networks are growing at a significant rate. This growth is driven by the demand for Internet services. As bandwidth demand continues to grow, new network technologies are required to support bandwidth capacities. Optical cross-connects (OXCS) represents a new category of network elements which promise to reduce networking equipment and operational costs for these high performance bandwidth networks.

There are two kinds of waveguide optical switches: one uses Mach-Zehnder interferometer (MZI) configurations and the other is a digital optical switch (DOS). The former can be either electro-optical switch (EOS) based on high EO effect materials such as LiNbO₃ and polymers, or thermo-optical switch (TOS) based on high TO effect materials such as polymers and silica. The DOS may only be TOS based due to currently available EO effect materials. The TOS using MZI configurations has an advantage of low power consumption, but the disadvantage of low reliability due to interference. The TOS based DOS configuration has the disadvantage of high power consumption, but the advantage of high reliability, because it is based on digital cut-off of the optical path. Therefore, the TOS based MZI configuration is suitable for both high and low thermal coefficient (dn/dT) if the material is reliable and stable both in time and temperature such as PECVD-based silica-on-silicon. The MZI configuration (based on waveguide technology) has two arms: one arm is heated to create an optical path-length difference with respect to the other arm. Thus, the output optical power depends on the temperature difference between the two paths. Several companies produce this type of device.

### SUMMARY OF THE INVENTION

In a preferred implementation, the present invention provides an optical waveguide switch using four Mach-Zehnder interferometer (MZI) units. These four MZI units are arranged as a 2×2 matrix to form a double-track 2-cascaded MZI configuration, which increases the isolation between the outputs and the extinction ratio at each output port. Two outputs from each MZI in the first column are separately connected to inputs of the other two MZI units in the second column. In the first column of MZIs, one input port of each MZI is used as input port and the other one as an idle port (not used). Likewise, in the second column of MZIs , one output port of each MZI is used as an output port and the other one as an idle port. Hence, an optical signal at the matrix input must pass through two MZI units, in contrast to the conventional 2×2 waveguide switches based on a single MZI unit, where an optical signal passes through a single MZI unit and isolation of more than 20 dB is difficult to achieve because of processing errors in making the waveguides. The extinction ratio is also limited by the isolation; since an optical signal through the present matrix has to pass through two MZI units in any event, given interference effects in two MZI units, the isolation of the present 2×2 optical switch can be twice as large as the conventional 2×2 optical switch based on a single MZI unit.

One modulating electrode is used for each MZI unit to change the optical phase by π. Every two electrodes in the same row of the MZI matrix are interconnected as one electrode to cause the optical signals launched into the input port of the same row of the MZI matrix to experience two Mach-Zehnder interfering effects. The extinction ratio is also doubled. Because the 2×2 switch based on the current invention uses more MZI units and the corresponding electrodes, it has more functions for any input optical signal than the conventional 2×2 optical switch based on a single MZI unit. The modulating form can be either the TO or the EO.

The 2×2 switch may be simplified to provide a 1×2 switch by omitting one row of the MZI matrix. An M×N switching matrix may be implemented using more than two of the present 2×2 waveguide switching matrix.

### BRIEF DESCRIPTION OF THE DRAWINGS

The preferred exemplary embodiments of the present invention will now be described in detail in conjunction with the annexed drawing, in which:

FIGS. 1(a), 1(e), 1(c) and 1(d) illustrate the configuration of a 2×2 waveguide switch according to the present invention using the double-track 2-cascaded Mach-Zehnder interferometers and the preferred connections of control electrodes, where FIG. 1(a) is a top view, FIG. 1(b) is a cross-section along the axis A-A, FIG. 1(c) shows the control electrodes connected in parallel and FIG. 1(d) shows the control electrodes connected in series;

FIG. 2 illustrates the configuration of a 1×2 waveguide switch using a single-track 2-cascaded Mach-Zehnder interferometers, where FIG. 2(a) is a top view and FIG. 2(b) is a cross section along the axis B-B;

FIG. 3 illustrates an alternative cross-section along the axis A-A of the 2×2 waveguide switch shown in FIGS. 1(a) and 1(b) based on vertical EO modulation, using two control electrodes for each waveguide; and

FIGS. 4(a) and 4(b) illustrate a configuration of a 2×2 waveguide switch using the double-track 2-cascaded Mach-Zehnder interferometers based on two electrodes for each waveguide, co-planar EO modulation where FIG. 4(a) is a top view and FIG. 4(b) is a cross-section along the axis C-C.

### DETAILED DESCRIPTION OF THE PREFERRED EMBODIMENTS

A waveguide switch based on the Mach-Zehnder interferometer (MZI) configuration has two 3 dB directional couplers connected by two waveguide arms. The switch exploits the phase property of light. The input light is split by one coupler and sent to two separate waveguide arms, then recombined and split again by the second coupler. One or both waveguide arms are modulated to produce a difference in optical path length between the two waveguide arms. The modulating means can be either thermo-optic (TO) or electro-optic (EO). If the two optical paths are the same length, light chooses one output of the second coupler, if they have a phase difference of π it chooses the other output port. As a 2×2 switch, for an input optical signal, the isolation between two output ports is important because it directly determines the ON/OFF extinction ratio of an output port. Meanwhile, the isolation is strongly dependent on the coupling ratio of the two 3 dB directional couplers. Namely, the closer the ratio is to 50% the higher is the isolation of the 2×2 switch, and the higher is the ON/OFF extinction ratio at each output port. In theory, if the coupling ratio of the 3 dB coupler is exactly 50% (i.e., −3 dB), the isolation between the two output ports should be infinity. In fact, no perfect 3 dB directional coupler exists, because errors in both design and fabrication, especially in fabrication, are not avoidable. So, it is difficult for 2×2 waveguide switches based on a single MZI unit to achieve an isolation of 20 dB. In practical fiber-optic communications, not only is an isolation of more than 20 dB often required for switching systems, but also isolation of more than 30 dB is necessary for some DWDM networks, such as typical optical add/drop multiplexing systems.

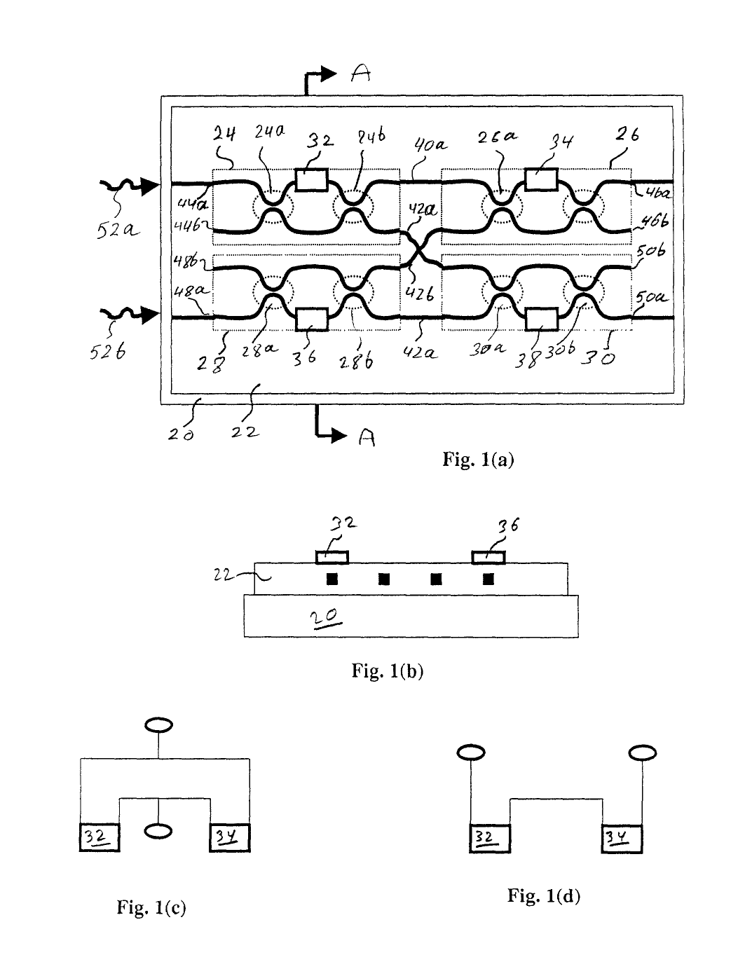

Referring now to FIGS. 1(a) and 1(b), the waveguide switch of the present invention comprises a substrate 20, cladding 22 and four waveguide MZI units 24, 26, 28 and 30 and four modulating electrodes 32, 34, 36 and 38 (they are also called heaters for thermal modulation). The MZI unit 24 comprises two 3 dB directional couplers 24a and 24b. The MZI unit 26 comprises two 3 dB directional couplers 26a and 26b. The MZI 28 comprises two 3 dB directional couplers 28a and 28b. The MZI unit 30 comprises two 3 dB directional couplers 30a and 30b. The four modulating electrodes 32, 34, 36 and 38 are used on the MZI units 24, 26, 28 and 30, respectively, to modulate the optical phase of one optical path of each MZI unit. Each MZI unit has two input ends and two output ends. One output end of the MZI unit 24 is directly connected to the tandem MZI unit 26 by waveguide path 40a and the other one is cross-connected to the MZI unit 30 by waveguide path 40b. In the same manner, one output end of the MZI unit 28 is directly connected to the tandem MZI unit 30 by waveguide path 42a and the other one is cross-connected to the MZI unit 26 by waveguide path 42b. So, the waveguide paths 40b and 42b have an intersection at 90° and do not interfere with each other. One input end 44a of the MZI unit 24 is used as an input port of the 2×2 switch for an optical signal 52a, and the other input end 44b is in idle state i.e. remains unconnected. Similarly, one output end 46a of the MZI unit 26 is used as an output port of the 2×2 switch and the other output end 46b is in idle state. In the same manner, one input end 48a of the MZI unit 28 is used as an input port of the 2×2 switch for an optical input signal 52b and the other input end 48b is in idle state. Similarly, one output end 50a of the MZI unit 30 is used as an output port of the 2×2 switch and the other output end 50b is in idle state. These two idle-state output ends are designed to receive the optical noise or the unexpected optical signals. In fact, an input optical signal now experiences twice the MZI effects, such that isolation between the two output ports 46a and 50a is doubled.

For simplicity, the TOS is taken as an example to describe the operation and the difference between the 2×2 optical switch based on the present invention and the conventional 2×2 optical switch using a single MZI configuration. Unlike the 2×2 switch using a single MZI configuration, where only one electrode is required to operate the optical signals launched from any input port, as shown in FIG. 1, the present 2×2 switch uses four electrodes, where the two electrodes 32 and 34 are required to switch optical signals launched into input port 44a and the two electrodes 36 and 38 are required to switch the optical signals launched from input port 48a. As shown in FIG. 1, the two electrodes deposited on the same track are used to operate the optical signals launched into this track. If an optical signal 52a is launched into the input port 44a, it is split into two parts at 50% coupling ratio by the 3 dB directional coupler 24a and then recombined into one optical signal again by the 3dB directional coupler 24b. If the electrode 32 is not activated (i.e., heated for a TOS) by a modulating signal (in the OFF-state), the optical signal 52a is sent into the waveguide path 40b as an input optical signal to the MZI unit 30. This input optical signal is further split into two parts at 50% coupling ratio by the 3 dB directional coupler 30a, and then recombined into one optical signal by the 3 dB directional coupler 30b. If the electrode 38 is not activated by a modulating signal (in the OFF-state), the combined optical signal exits at the output port 50a of the MZI unit 30, which is one of the two output ports of the 2×2 switch. For the same optical signal 52a launched into the 3 dB directional coupler 24a, when the electrode 32 is activated by a modulating signal (in the ON-state), this optical signal exits at the waveguide path 40a as an input optical signal to the MZI unit 26. So, it is further split into two parts and sent to two arms at 50% coupling ratio by the 3 dB directional coupler 26a and recombined into one optical signal again by the 3 dB directional coupler 26b. If the electrode 34 is also activated, this optical signal exits at the output end 46a of the 3 dB directional coupler 26b. As mentioned above, the end 46a is one of the two output ports of the 2×2 waveguide switch. Thus, the optical signal 52a launched into the input port 44a can have two possible outputs 50a or 46a by not activating both electrodes 32 and 34 (both in the OFF-state), or activating both electrodes 32 and 34 (both in the ON-state), respectively. Thus, switching of the input signal 52a is accomplished The same switching process is also performed if an optical signal 52b is launched into the input port 48a of the MZI unit 28 by not activating both electrodes 36 and 38 (in the OFF-state), or by activating both electrodes 36 and 38 (in the ON-state). Hence, the 2×2 switching process is implemented with the present double-track 2-cascaded MZI configuration. Of course, the two electrodes 32 and 34 must be operated simultaneously and used as one modulating electrode to switch the optical signals such as 52a launched into the input port 44a of the 2×2 switch, The same applies for the electrodes 36 and 38 to switch the optical signals such as 52b launched into the input port 48a of the 2×2 switch. Two electrode interconnection methods may be used: in parallel or in series as shown in FIGS. 1(c) and FIG. 1(d), respectively.

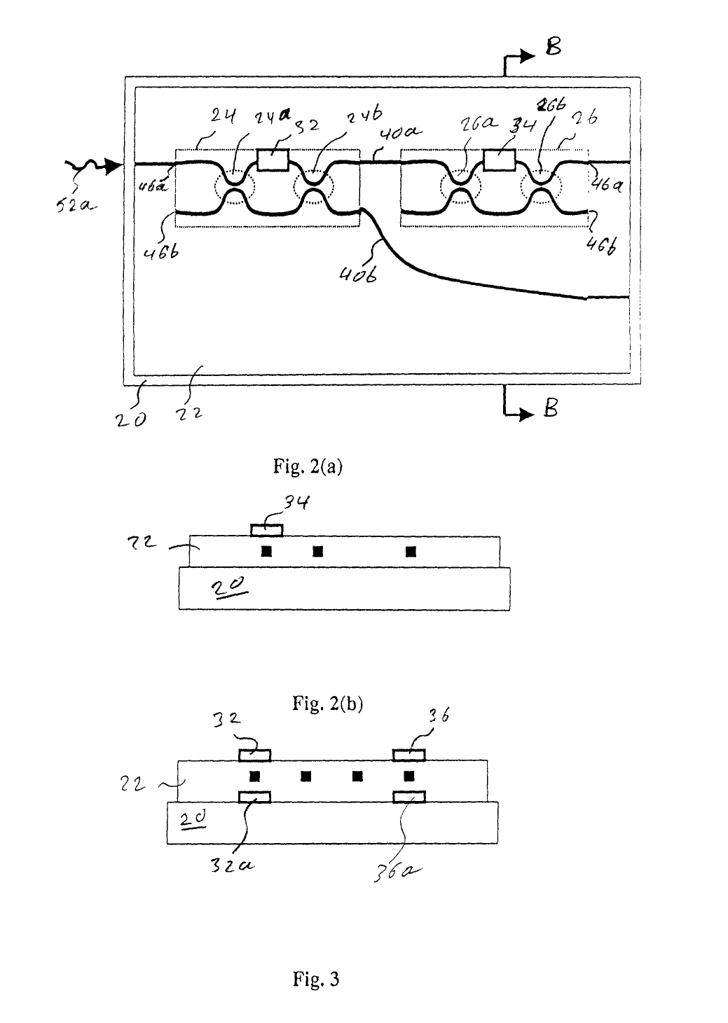

Referring now to FIGS. 2(a) and 2(b), a 1×2 optical switch may be realized. The present 2×2 optical switch using eight 3 dB directional couplers may be simplified to yield a 1×2 optical switch using four 3 dB directional couplers as shown. The four 3 dB directional couplers are 24a, 24b, 26a and 26b are used to form a single-track 2-cascaded MZI configuration and two electrodes 32 and 34 are used to modulate the two MZI units 24 and 26. The isolation for the 1×2 optical switch should be approximately the same as that for the 2×2 switch as described above.

Because the present 2×2 switch uses more MZI unites and the corresponding number of electrodes, it provides more functions for any input optical signal than the conventional 2×2 optical switch based on a single MZI unit. For example, an optical signal 52a will have of no output when both the electrodes 32 and 34 are not activated while at the same time both the electrodes 36 and 38 are activated. The same applies to the optical signal 52b when both the electrodes 36 and 38 are not activated while at the same time both the electrodes 32 and 34 are activated Even when the two optical signals 52a and 52b are input into 44a and 48a; respectively, at the same time, the 2×2 optical switch still provides this additional function just described.

Referring now to FIG. 3, it shows a cross-section in the plane A-A (corresponding to that in FIG. 1(a)) for an EOS, where the top view of such an electro-optically modulated switch is identical to that shown in FIG. 1(a). For electro-optical modulation of the waveguide it is necessary to provide two electrodes across which a potential difference is applied. Therefore, the top electrode, 32 and 36 in FIG. 3 have bottom counterpass electrodes 32a and 36a, with the modulating electrical signal applying a potential difference between 32/36 and 32a/36a in order to create a refractive index modulating field between (32 and 32a) and (36 and 36a), thus inducing the requisite phase shift in the waveguides in between.

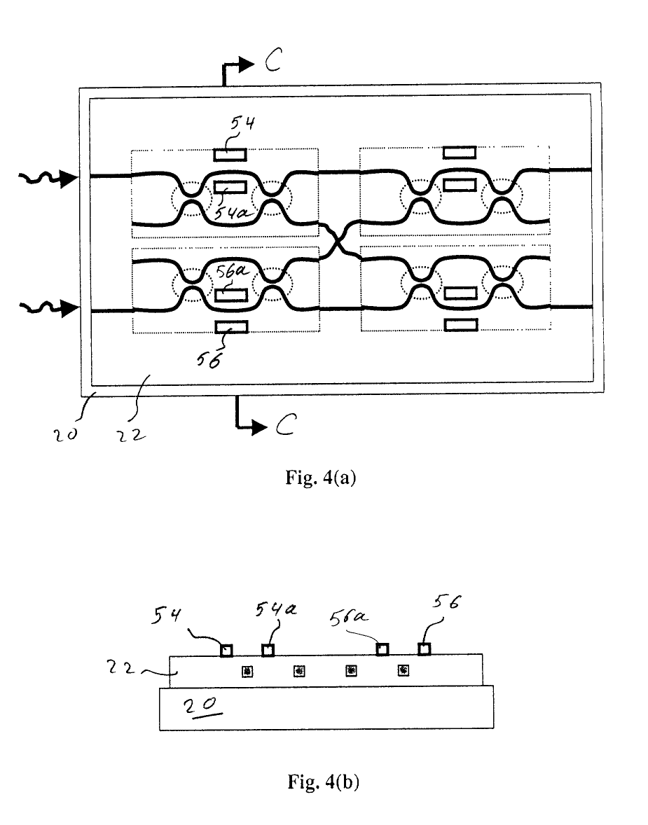

FIGS. 4(a) and 4(b) show an alternative arrangement to that of FIG. 3, wherein the electro-optical modulating electrodes are deposited on the top surface on ether side of a waveguide. The modulating potential difference is thus applied between electrodes (54 and 54a) and (56 and 56a). Of course, structure and operation of the electro-optically controlled 1×2 or 2×2 switches is identical to the TOS switches in all other respects.

As mentioned above, the directional couplers with a coupling ratio of 50%, known as 3 dB directional coupler, are the most useful optical function elements in the 2×2 optical switch based of the present invention. As shown in FIG. 1(a), four MZI units are formed with eight 3 dB directional couplers. Each MZI unit consists of two 3 dB directional couplers and two waveguide arms of the same length. One of the waveguide arms has deposited thereon a metal electrode (which is called a heater for thermal modulation, while for electrical modulation, two electrodes must be used to replace one heater electrode).

Because an optical signal passes through two MZI units no matter which optical path is selected, the optical characteristics of the switch, such as the isolation between the two outputs, the switching extinction ratio, the wavelength dependence and the optical propagation loss across the device are approximately twice that of a single MZI unit. The following analysis considers one MZI unit. For a 3 dB directional coupler, if the input optical power is P₀ and the output powers of the 3 dB directional coupler are P₁ and P₂ at the bar-state port and the cross-state port, respectively, the coupling ratio k and the coupling loss L_{c} of the 3 dB directional coupler are defined by

$$\begin{matrix}k = \frac{{P}_{2}}{{P}_{1} + {P}_{2}} & \text{(1a)} \\ {L}_{c} = 10 {log}_{10} ( \frac{{P}_{o}}{{P}_{1} + {P}_{2}} ) & \text{(1b)}\end{matrix}$$

Assuming the change of the refractive index of the waveguide produced by the modulation is Δn, the phase difference between two waveguide arms of the MZI unit should be

$$Δ φ = \frac{2 π L Δ n}{λ} \qquad ( 2 )$$

where L is the length of the modulated waveguide (i.e., the length of the electrode) and λ is wavelength in vacuum. For the TO modulation, Δn is related to the temperature change ΔT by the TO coefficient dn/dT of the waveguide material as

$$Δ n = \frac{ⅆ n}{ⅆ T} Δ T$$

For the EO modulation, An is related to the applied electrical field E by the EO coefficient r₃₃ of the waveguide material as

$$Δ n = - \frac{1}{2} {r}_{33} {n}^{3} E ,$$

where n is the refractive index of the EO waveguide material. Then the two output efficiencies of one MZI unit are

$$\begin{matrix}{η}_{1} ( 1 ) = {( 1 - 2 k )}^{2} {cos}^{2} ( \frac{Δ φ}{2} ) + {sin}^{2} ( \frac{Δ φ}{2} ) & \text{(3a)} \\ {η}_{2} ( 1 ) = 4 k ( 1 - k ) {cos}^{2} ( \frac{Δφ}{2} ) & \text{(3b)}\end{matrix}$$

where η₁(1) and η₂(1) are the output efficiencies (i.e., the normalized output power) at the bar-state output port and the cross-state output port, respectively, and Δφ is the change induced by the modulation. When

$$Δ φ = π ( Δ n = \frac{λ}{2 L} , )$$

a switch based on single MZI unit can produce a switching process, and Δφ=0 is the off-state. In the off-state, the refractive index change Δn is 0 and Eqs. (3a) and (3b) can be written as

η₁(1)=(1−2k)², and (4a)

η₂(1)=4k(1−k). (4b)

Thus, the isolation between two output ports of the single MZI unit (i.e., the isolation of the conventional 2×2 optical switch) should be

$$Iso\_MZI = 10 {log}_{10} ( \frac{{η}_{2} ( 1 )}{{η}_{1} ( 1 )} ) . \qquad \text{(5)}$$

In the 2×2 optical switch based on the present invention, because any optical signal has to pass through two MZI units, the two output efficiencies at two output ports of the 2×2 optical switch should be

η₁(2)=η₁²(1), and (6a)

η₂(2)=η₂²(1). (6b)

Thus the isolation between two output ports of the present 2×2 optical switch should be defined by

$$Iso\_switch = 10 {log}_{10} [ \frac{{η}_{2} ( 2 )}{{η}_{1} ( 2 )} ] . \qquad \text{(7)}$$

Hence, the following advantages expression is obtained

Iso_switch=2*Iso_MZI. (8)

The extinction ratio at any output port (the bar-state port or the cross-state port) is also increased to twice that of the conventional 2×2 optical switch.

1. An optical signal switch, comprising:
(a) at least first and second Mach-Zehnder Interferometers ((MZI) each having at least one input for receiving an optical signal and at least one output for outputting said optical signal;
(b) said first and second MZIs being optically interconnected, the output of the first to the input of the second; and
(c) at least one refractive index-modulating electrode in one arm of each of said first and second MZIs

2. The optical signal switch of claim 1, said first and second MZIs each being symmetrical in structure except for the presence of the modulating electrode in one arm.

3. The optical signal switches of claim 2, further comprising third and fourth MZIs likewise interconnected as said first and second MZIs.

4. The optical signal switches of claim 3, further comprising a second output in each of said first and third MZTs.

5. The optical signal switches of claim 4, further comprising a second input in each of said second and fourth MZIs.

6. The optical signal switches of claim 5, wherein said second output of said first MZI is interconnected with the second input of said fourth MZI.

7. The optical signal switch of claim 6, wherein said second output of said third MZI is interconnected to said second input of said second MZI.
